(19) United States
(12) Patent Application Publication
(10) Pub. No.: US 2026/0029584 A1
(43) Pub. Date: Jan. 29, 2026

(54) Optical coupling for heterogeneous photonic integration

(71) Applicant: Quantum Transistors Technology Ltd., Binyamina (IL)

(72) Inventors: Igal I Bayn, New York, NY (US); Thomas Ferreira de Lima, Princeton, NJ (US); Moshe Tordjman, Haifa (IL)

(21) Appl. No.: 19/277,490

(22) Filed: Jul. 23, 2025

Related U.S. Application Data
(60) Provisional application No. 63/674,814, filed on Jul. 24, 2024.

(51) Int. Cl. G02B 6/30; G06N 10/40

(52) U.S. Cl. CPC G02B 6/305; G06N 10/40

(57) ABSTRACT

Systems and methods for optical coupling are disclosed. An optical coupler for operation at a target wavelength includes a layer of a first dielectric material having a first refractive index at the target wavelength; a first ridge including the first dielectric material, disposed on the layer along a first axis, configured to guide an optical wave at the target wavelength and terminating at a first termination point; and a second ridge including a second dielectric material having a second refractive index greater than the first refractive index at the target wavelength, disposed along a second axis, parallel to the first axis, and terminating in a taper, disposed on the layer, having a varying width that decreases in a direction, along the second axis to a second termination point in proximity to the first termination point, whereby the guided optical wave is adiabatically coupled between the first and second ridges.

### CROSS-REFERENCE TO RELATED APPLICATIONS

This application claims priority to U.S. Provisional Patent Application No. 63/674,814, titled “Diamond-Qubit-to-PIC Coupler for Scalable Heterogeneous Integration”, filed Jul. 24, 2024, which is hereby incorporated by reference in its entirety.

### FIELD OF INVENTION

The present disclosure relates to optical coupling, and more particularly to systems, devices and methods for scalable and heterogeneous optical coupling.

### BACKGROUND

Photonic integrated circuits (PICs) have emerged as a promising platform for various applications, including quantum computing, optical communications, and sensing. These circuits leverage the manipulation of light at the microscale to process and transmit information. PICs can be fabricated using established semiconductor manufacturing techniques and materials such as silicon nitride, which offers low optical loss and compatibility with existing Complementary Metal-Oxide-Semiconductor (CMOS) processes.

In the field of quantum computing, PICs play a crucial role in facilitating the manipulation and transmission of quantum information using light. However, efficiently coupling light between different optical components or materials, such as diamond-based qubits and PIC waveguides, remains a complex task. This complexity arises due to differences in refractive indices, mode profiles, and geometric constraints between the various components.

Heterogeneous integration techniques, where different materials are combined on a single chip, have been explored as a potential solution for interfacing between different optical components or materials. These methods often involve precise alignment and bonding of separate components. However, scaling these techniques for large-scale quantum processors, for example, can be challenging, as maintaining high coupling efficiencies across a range of operating conditions and fabrication tolerances is essential for practical quantum computing systems.

The development of efficient and scalable coupling mechanisms, e.g., between diamond-based qubits and photonic integrated circuits, may enable more advanced quantum processors. Such advancements could potentially accelerate the development of practical quantum computing systems for a wide range of applications.

In addition to quantum computing, improved optical coupling techniques may benefit other fields that rely on heterogeneous integration of photonic components. These fields may include telecommunications, where high-bandwidth optical interconnects are crucial, and sensing, where the integration of different materials can enhance detection capabilities.

As research in photonics and quantum technologies progresses, there is an ongoing need for innovative approaches to optical coupling that can address the challenges of scalability, efficiency, and compatibility across diverse material systems and device architectures.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In accordance with aspects of the present disclosure, an optical coupler for operation at a target wavelength includes a layer, a first ridge and a second ridge. The layer is of a first dielectric material, having a first refractive index at the target wavelength. The first ridge includes the first dielectric material, which is disposed on the layer along a first axis and is configured to guide an optical wave at the target wavelength. The first ridge terminates at a first termination point. The second ridge includes a second dielectric material, which has a second refractive index greater than the first refractive index at the target wavelength. The second ridge is disposed along a second axis, which is parallel to the first axis, and terminates in a taper, disposed on the layer, having a varying width that decreases in a direction along the second axis to a second termination point in proximity to the first termination point, where the guided optical wave is adiabatically coupled between the first and second ridges.

In various embodiments of the optical coupler, the first dielectric material is silicon nitride (SiN).

In various embodiments of the optical coupler, the second dielectric material is diamond.

In various embodiments of the optical coupler, the second dielectric material includes Lithium Niobate or Barium Titanate.

In various embodiments of the optical coupler, the first ridge terminates in a first taper having a first varying width that decreases in a first direction along the first axis to the first termination point and the second ridge terminates in a second taper that decreases in a second direction, opposite the first direction, along the second axis to the second termination point.

In various embodiments of the optical coupler, the second axis is displaced transversely from the first axis by a separation where the first and second tapers overlap in a projection of the first axis onto the second axis.

In various embodiments of the optical coupler, the first and second tapers do not overlap in a projection of the first axis onto the second axis.

In various embodiments of the optical coupler, the first axis and the second axis are aligned.

In various embodiments of the optical coupler, the second axis is displaced transversely from the first axis by a separation.

In various embodiments of the optical coupler, the first and second tapers do not overlap in a projection of the first axis onto the second axis and the second axis is displaced transversely from the first axis by a separation which is ±30% of the target wavelength.

In various embodiments of the optical coupler, the length of the first taper is between twice and twenty times the target wavelength.

In various embodiments of the optical coupler, an end portion of the second ridge, opposite the second taper, is suspended in or disposed on a third transparent dielectric material having a third refractive index lower than the second refractive index.

In various embodiments of the optical coupler, the end portion of the second ridge is suspended in air.

In various embodiments of the optical coupler, the error in displacement along the first and second axes of the second termination point of the second taper with respect to the point along the first ridge at which the first taper begins is within a range of ±150% of the target wavelength.

In various embodiments of the optical coupler, the first and second tapers taper asymmetrically.

In various embodiments of the optical coupler, the first and second tapers overlap in a projection of the first axis onto the second axis and the second axis is displaced transversely from the first axis by a separation which is between 23% and 70% the target wavelength.

In various embodiments of the optical coupler, at least one taper of the first and second tapers tapers symmetrically.

In various embodiments of the optical coupler, the second ridge is mounted on a metal film disposed over the layer of the first dielectric material so that there is an air gap between the second ridge and the layer.

In various embodiments of the optical coupler, the optical coupler further includes a substrate, where the layer is disposed on the substrate.

In accordance with aspects of the present disclosure, a quantum processor includes multiple qubits, one or more Photonic Integrated Circuit (PIC) platforms, and multiple optical couplers, as disclosed herein. Each optical coupler is disposed on a respective PIC platform of the one or more PIC platforms. Each optical coupler is configured to couple between one or more qubits of the multiple qubits and the respective PIC platform.

In various embodiments of the quantum processor, the one or more qubits are diamond qubits.

In various embodiments of the quantum processor, the second ridge is a diamond including the one or more diamond qubits.

In various embodiments of the quantum processor, the second ridge includes an end portion opposite the second taper, where the end portion includes a cavity hosting a color center.

In various embodiments of the quantum processor, the color center is a nitrogen-vacancy (NV) center.

In accordance with aspects of the present disclosure, a method for fabricating an optical coupler for operation at a target wavelength includes fabricating a layer of a first dielectric material, having a first refractive index at the target wavelength; fabricating a first ridge along a first axis on the layer, where the first ridge includes the first dielectric material, and terminates at a first termination point; fabricating a second ridge including a second dielectric material, having a second refractive index greater than the first refractive index at the target wavelength, and terminating in a taper having a varying width that decreases to a second termination point; and positioning the second ridge and bonding at least the taper onto the layer along a second axis, parallel to the first axis, such that the varying width of the taper decreases in a direction along the second axis to the second termination point in proximity to the first termination point.

In various embodiments of the method, the positioning and bonding of the second ridge is performed by micro-transfer printing.

In various embodiments of the method, the method further includes applying glass passivation to the optical coupler subsequent to the positioning and bonding of the second ridge.

In various embodiments of the method, the method further includes positioning and bonding the layer onto a substrate.

In various embodiments of the method, fabricating the layer includes forming the layer on a substrate.

In various embodiments of the method, the first dielectric material is silicon nitride (SiN).

In various embodiments of the method, the second dielectric material is diamond.

In various embodiments of the method, the second dielectric material includes Lithium Niobate or Barium Titanate.

In various embodiments of the method, the first ridge terminates in a first taper having a first varying width that decreases in a first direction along the first axis to the first termination point. The second ridge terminates in a second taper that decreases in a second direction, opposite the first direction, along the second axis to the second termination point. Positioning and bonding of the second ridge is then performed so that the second varying width of the second taper decreases in a second direction, opposite the first direction, along the second axis to the second termination point.

In various embodiments of the method, positioning of the second ridge and bonding of at least the second taper onto the layer is performed so that the second axis is displaced transversely from the first axis by a separation and the first and second tapers overlap in a projection of the first axis onto the second axis.

In various embodiments of the method, positioning of the second ridge and bonding of at least the second taper onto the layer is performed so that the first and second tapers do not overlap in a projection of the first axis onto the second axis.

In various embodiments of the method, positioning of the second ridge and bonding of at least the second taper onto the layer is performed so that the first axis and the second axis are aligned.

In various embodiments of the method, positioning of the second ridge and bonding of at least the second taper onto the layer is performed so that the second axis is displaced transversely from the first axis by a separation.

In various embodiments of the method, the first and second tapers do not overlap in a projection of the first axis onto the second axis, where positioning of the second ridge and bonding of at least the second taper onto the layer is performed so that the second axis is displaced transversely from the first axis by a separation which is ±30% of the target wavelength.

In various embodiments of the method, the length of the first taper is between twice and twenty times the target wavelength.

In various embodiments of the method, positioning of the second ridge and bonding of at least the second taper onto the layer is performed so that an end portion of the second ridge, opposite the second taper, is suspended in or disposed on a third transparent dielectric material having a third refractive index lower than the second refractive index.

In various embodiments of the method, the end portion of the second ridge is suspended in air.

In various embodiments of the method, the first and second tapers taper asymmetrically.

In various embodiments of the method, the first and second tapers overlap in a projection of the first axis onto the second axis, and positioning of the second ridge and bonding of at least the second taper onto the layer is performed so that the second axis is displaced transversely from the first axis by a separation which is between 23% and 70% the target wavelength.

In various embodiments of the method, at least one taper of the first and second tapers tapers symmetrically.

In various embodiments of the method, the method further includes depositing a metal film over the layer, where positioning of the second ridge and bonding of at least the second taper onto the layer includes mounting the second ridge onto the metal film so that there is an air gap between the second ridge and the layer.

The foregoing general description of the illustrative embodiments and the following detailed description thereof are merely exemplary aspects of the teachings of this disclosure and are not restrictive.

### BRIEF DESCRIPTION OF THE FIGURES

The above and other aspects and features of the disclosure will become more apparent in view of the following detailed description when taken in conjunction with the accompanying drawings wherein like reference numerals identify similar or identical elements.

FIG. 1 illustrates a perspective view, partially transparent, of an exemplary optical coupler disposed on a PIC, according to aspects of the present disclosure;

FIG. 2A illustrates a top view of a portion of an optical coupler, according to aspects of the present disclosure;

FIG. 2B illustrates a cross-sectional view of the optical coupler of FIG. 1, taken along line B-B of FIG. 1, according to aspects of the present disclosure;

FIG. 2C illustrates another cross-sectional view of the optical coupler of FIG. 1, taken along line E-E of FIG. 1, according to aspects of the present disclosure;

FIG. 3 illustrates a perspective view partially transparent, of another exemplary optical coupler, coupling between a PIC and a qubit, according to aspects of the present disclosure;

FIG. 4A illustrates a side view along a plane x-z of a further exemplary optical coupler, disposed on a PIC, according to aspects of the present disclosure;

FIG. 4B illustrates cross-section views of the second ridge and the layer of the optical coupler of FIG. 4A along a plane y-z at the base of the second taper, as positioned one with respect to the other, according to aspects of the present disclosure.

FIG. 5 illustrates a schematic block diagram of a quantum processor including multiple optical couplers, according to aspects of the present disclosure; and

FIG. 6 illustrates a flowchart of a method for fabricating an optical coupler, according to aspects of the present disclosure.

It will be appreciated that for simplicity and clarity of illustration, elements shown in the figures have not necessarily been drawn to scale. For example, the dimensions and/or aspect ratio of some of the elements can be exaggerated relative to other elements for clarity. Further, where considered appropriate, reference numerals can be repeated among the figures to indicate corresponding or analogous elements throughout the several views.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to optical coupling devices and methods for heterogeneous photonic integration and to quantum processors utilizing such optical coupling. Optical coupling between different materials and components may be important for various applications in integrated photonics. According to some aspects, efficient transfer of optical signals between dissimilar materials or structures is desirable.

The optical coupling devices and methods described herein may provide advantages such as improved coupling efficiency, relaxed alignment tolerances, and compatibility with existing fabrication processes. According to some aspects, the disclosed optical couplers may enable integration of components with different material properties or geometries. For example, the disclosed optical coupler may facilitate interfacing between silicon nitride waveguides and diamond-based quantum components.

The optical coupling approach described may be applicable to various photonic integrated circuit (PIC) platforms and optical materials. The disclosed optical coupling may be configured for operation at a desired target wavelength. According to some aspects, the disclosed optical couplers may facilitate coupling between waveguide structures formed from different dielectric materials. The coupling may be achieved through specially designed tapered structures that allow for adiabatic mode conversion between the coupled components.

In some implementations, the disclosed optical coupling devices and methods may be applied to quantum computing systems. For example, the optical couplers may enable integration of quantum components, such as qubits, with photonic integrated circuits. According to some aspects, an optical coupler, as disclosed, may be used to interface one or more qubits with a PIC platform in a quantum processor. According to some aspects, a qubit may be a diamond-based qubit. This approach may allow for scalable architectures combining quantum processing elements with integrated photonic circuitry.

An optical coupler for operation at a target wavelength may include a layer, a first ridge and a second ridge. According to some aspects, the optical coupler may further include a substrate (e.g., a PIC), where the layer is disposed on the substrate. The layer may be of a first dielectric material having a first refractive index at the target wavelength. According to some aspects, the first dielectric material may be silicon nitride (SiN). According to some aspects, the layer may be disposed on a substrate. According to some aspects, the layer may be a slab. The first ridge may include the first dielectric material. The first ridge may be disposed on the layer along a first axis. The first ridge may be configured to guide an optical wave at the target wavelength. The first ridge may terminate at a first termination point. According to some aspects, the first ridge may terminate in a first taper having a first varying width that decreases in a first direction along the first axis to the first termination point.

The second ridge may include a second dielectric material, different from the first dielectric material. The second dielectric material may have a second refractive index greater than the first refractive index at the target wavelength. According to some aspects, the second dielectric material may be diamond. The second ridge may be disposed along a second axis, which may be parallel to the first axis. According to some aspects, the second axis may be displaced transversely from the first axis by a separation. This separation may allow a continuous mode overlap during light propagation between the first and the second axes. According to some aspects, the second ridge may terminate in a taper, disposed on the layer, having a varying width that decreases in a direction, along the second axis, to a second termination point in proximity to the first termination point. In a configuration where the first ridge includes the first taper, the second ridge may terminate in a second taper, disposed on the layer, having a second varying width that decreases in a second direction, opposite the first direction, along the second axis to a second termination point in proximity to the first termination point. According to some aspects, only a portion of the second ridge, e.g., the second taper or at least the second taper, may be disposed on the layer. According to some aspects, the entire second ridge may be disposed on the layer.

Although the disclosed figures show the first ridge and the second ridge as being tapered, in alternative embodiments one or both of the ridges may terminate without a taper. For example, an optical coupler configured for green light may include a first ridge which terminates with a rectangular shape rather than a taper.

The disclosed optical coupler includes a transition region, where the first taper and the second taper overlap or come into close proximity. A non-overlapping configuration may provide higher coupling at more relaxed placement precision in the axis which is transverse to the longitudinal axes of the first and second ridges (will be referred to hereinbelow as the y-axis). According to some aspects, a stricter alignment in the longitudinal axes of the first and second ridges (will be referred to herein as the x-axis) may be required, as compared to the overlapping geometry.

The transition region may facilitate the adiabatic coupling of the guided optical wave between the first ridge and the second ridge. The tapered structures of the first and second ridges and their disposition on the layer may facilitate adiabatic mode conversion between the coupled components. As the optical wave propagates along the first ridge, the mode may gradually transform due to the decreasing width of the first taper. Simultaneously, the increasing width of the second taper may allow the optical mode to couple into the second ridge. This gradual transformation of the optical mode between the dissimilar materials may enable efficient power transfer while minimizing reflections or scattering losses. The adiabatic nature of the coupling may provide robustness against misalignments or fabrication variations.

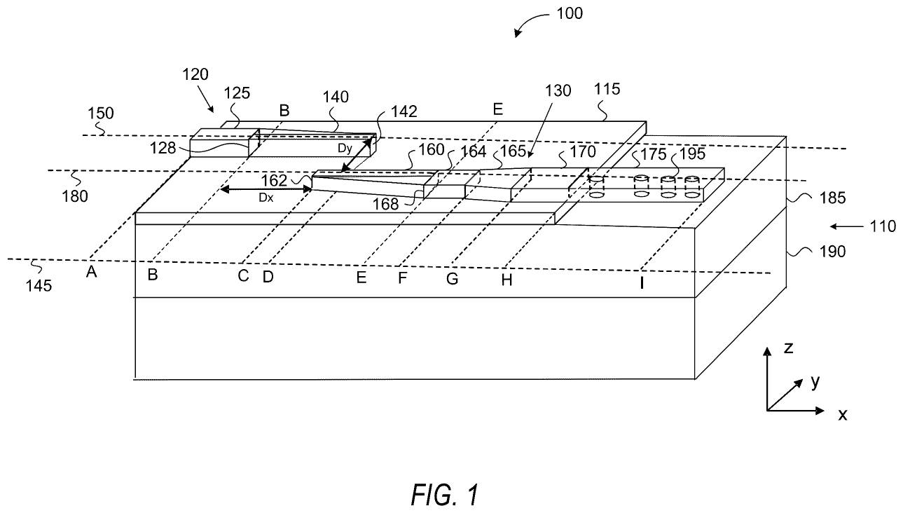

Reference is now made to FIG. 1, which shows a perspective view, partially transparent, of an exemplary optical coupler 100. FIG. 1 illustrates a coupler structure that facilitates coupling between different optical components. The structure includes multiple layers and regions arranged to enable efficient transfer of optical signals between dissimilar materials or devices. This configuration may be particularly useful for interfacing between photonic integrated circuits (PICs) and quantum components such as qubits.

Optical coupler 100 includes a layer 115 of a dielectric material having a refractive index at the target wavelength. The dielectric material may be, for example, Silicon Nitride (SiN). Layer 115 is disposed on a PIC 110. PIC 110 may include a Buried Oxide (BOX) or Thermal Oxide (ThOX) layer 185 disposed on a substrate 190. Substrate 190 may be a Silicon (Si) substrate.

Optical coupler 100 further includes a ridge 120, which includes the dielectric material of layer 115 and is disposed on layer 115 along an axis 150. Ridge 120 may be, for example, a SiN ridge. Ridge 120 is configured to guide an optical wave at the target wavelength. Ridge 120 terminates in a taper 140 having a varying width that decreases in a direction along axis 150 to a termination point 142. Axis 150 is parallel to the x-axis of the frame of reference of FIG. 1 (as shown there). The varying width of taper 140 decreases in the positive direction of the x-axis. According to some aspects, the length of taper 140 may be between twice and twenty times the target wavelength to facilitate the use of micro-transfer printing.

Optical coupler 100 further includes a ridge 130, which includes another dielectric material different from the dielectric material of ridge 120 and layer 115. The dielectric material of ridge 130 has a refractive index greater than the refractive index of the dielectric material of ridge 120 at the target wavelength. According to some aspects, the dielectric material of ridge 130 is diamond. According to some aspects, the dielectric material of ridge 130 may include Lithium Niobate or Barium Titanate. Ridge 130 is disposed along an axis 180, which is parallel to axis 150. Ridge 130 terminates in a taper 160 which is disposed on layer 115. Taper 160 has a varying width that decreases in a direction, opposite the direction at which the varying width of taper 140 decreases, along axis 180 to a termination point 162 in proximity to termination point 142. The varying width of taper 160 decreases in the negative direction of the x-axis. Taper 160 has a base 168, at which the varying width is the largest.

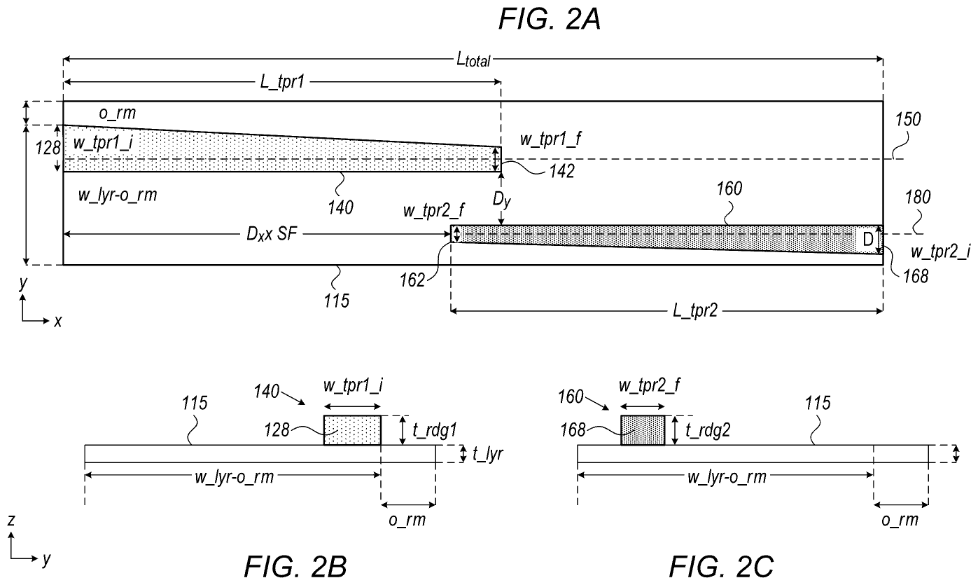

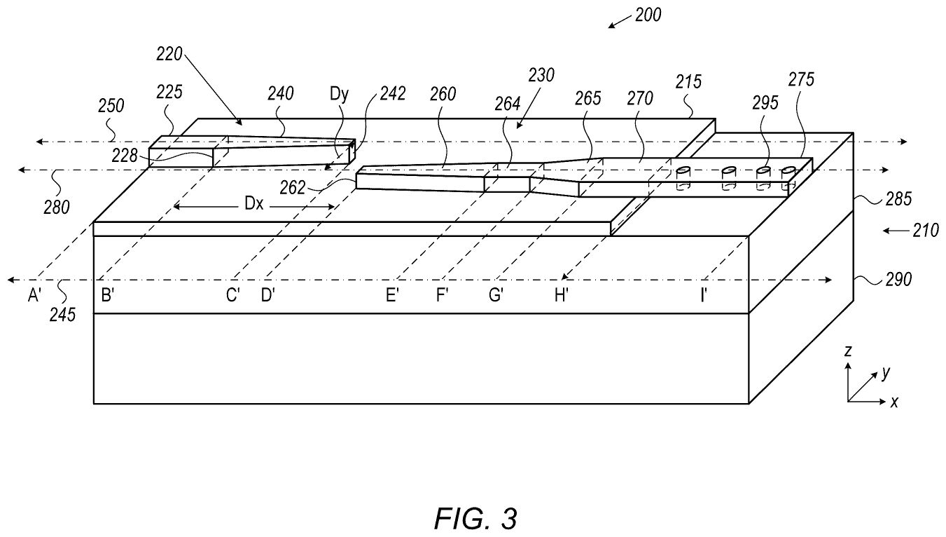

According to some aspects, the first axis of the first ridge and the second axis of the second ridge (e.g., axes 150 and 180, respectively, of FIGS. 1 and 2A or axes 250 and 280, respectively of FIG. 3) may pass through the middle of the termination point of the first ridge and the second ridge, respectively, as shown in FIGS. 1, 2A and 3 and as exemplified hereinbelow. According to some aspects, axes 150 and 180 may pass through the center of ridge 120 and 130, respectively. According to some aspects, the center of a ridge may correspond to the geometric center of the ridge cross-section, the point of maximum field intensity for the fundamental optical mode, or another reference point relevant to the design or fabrication of the optical coupler.

An optical coupler, as disclosed, may include additional regions associated with the ridges, as shown in the example of FIG. 1. These regions correspond to different functional areas of the optical coupler. Ridge 120 includes a waveguide region 125 disposed on layer 115 and ridge 130 includes a waveguide region 164 disposed on layer 115. Waveguide regions 125 and 164 are configured to guide light to and from taper 140 and taper 160, respectively. Furthermore, waveguide regions 125 and 164 may provide a region for mode stabilization before light enters taper 140 and taper 160, respectively. According to some aspects, such a waveguide region may serve as an interface to other components on the substrate on which the optical coupler is disposed (e.g., PIC 110).

According to some aspects, as shown in FIG. 1, ridge 130 may include a qubit region 175 configured to couple ridge 130 with one or more qubits. According to some aspects, qubit region 175 may potentially host the one or more qubits in cavities such as cavity 195. According to some aspects, ridge 130 may further include additional regions such as taper 165 and interface 170, which will be discussed hereinbelow.

A further axis 145, parallel to axes 150 and 180, is shown in FIG. 1. A plurality of points A-I along axis 145 indicate the projection of the various components or regions of optical coupler 100, including ridges 120 (indicated by section AD along axis 145) and 130 (indicated by section CI along axis 145), onto axis 145. According to some aspects, axis 180 may be displaced transversely (e.g., along the y-axis of the frame of reference) from axis 150 by a separation, indicated Dy, as shown in FIG. 1. According to some aspects, the error in displacement (or placement) along axis 180 of termination point 162 of taper 160 from the projection of a base 128 of taper 140 (e.g., at which taper 140 begins or has the largest width) onto axis 180 (indicated Dx) may be within a range of 940%±150% of the target wavelength. Dx is also indicated in FIG. 1 by section BC along axis 145.

According to some aspects, as exemplified in FIG. 1, the tapers of the optical coupler may have overlapping projections on the x-axis. Accordingly, tapers 140 (indicated by section BD along axis 145) and 160 (indicated by section CE along axis 145) overlap in a projection of axis 150 onto axis 180. The overlapping region or length is indicated by section CD along axis 145. According to some aspects, the tapers may taper asymmetrically, as exemplified in FIG. 1. The asymmetric tapering may, inter alia, help achieve better mode matching, allow for a more gradual and adiabatic transition of the optical mode and optimize the coupling efficiency between the two different ridges (e.g., ridge 120 and ridge 130 of FIG. 1). This may allow higher variation of Dx and greater ease in micro-transfer printing operations.

According to some aspects, an end portion of the second ridge (e.g., ridge 130), opposite the second taper (e.g., taper 160), may be suspended in or disposed on a third transparent dielectric material having a third refractive index lower than the second refractive index. According to some aspects, the third refractive index may also be lower than the first refractive index. For example, as shown in FIG. 1, an end portion of ridge 130, qubit region 175, also indicated by section HI along axis 145, is suspended in air. According to some aspects, ridge 130 may include additional regions such as taper 165 (indicated by section FG along axis 145) and interface 170 (indicated by section GH along axis 145).

Taper 165 is disposed between waveguide region 164 and interface 170. Taper 165 has a varying width that increases in the same direction as the varying width of taper 160 increases, along axis 180 and in the negative direction of the x-axis to decrease parasitic reflection at the end of interface 170 located at the edge of layer 115 (indicated by point H along axis 145).

Interface 170 is disposed between taper 165 and qubit region 175. At the end of interface 170 (indicated by point H on axis 145) layer 115 ends, and the air gap appears, below qubit region 175 (e.g., below the diamond membrane layer). According to some aspects, taper 165 and interface 170 are introduced to allow the cavity (e.g., cavity 195) to be suspended in air, resulting in a higher Q-factor in the cavity region, while maintaining high coupling efficiency.

Reference is now made to FIGS. 2A-2C. FIG. 2A shows a top view of a portion of optical coupler 100, including taper 140 and taper 160 of FIG. 1 (indicated by section BE along axis 145 of FIG. 1). FIG. 2B illustrates a cross-sectional view of optical coupler 100 of FIG. 1, taken along line B-B of FIG. 1. FIG. 2C illustrates another cross-sectional view of optical coupler 100 of FIG. 1, taken along line E-E of FIG. 1.

As shown in FIG. 2A, taper 140 is disposed on layer 115 along axis 150. The varying width of taper 140 initiates with a width indicated w_tpr1_i that decreases in a direction along axis 150 (e.g., in the positive direction of the x-axis of the frame of reference of FIG. 2A) to termination point 142 having a width indicated w_tpr1_f. According to some aspects, the length of the first taper, indicated L_tpr1, may be between twice and twenty times the target wavelength. Taper 160 is disposed on layer 115 along axis 180, which is parallel to axis 150. According to some aspects, axis 180 may be displaced transversely (e.g., along the y-axis of the frame of reference of FIG. 2A) from axis 150 by a separation Dy. The varying width of taper 160 initiates with a width indicated w_tpr2_i that decreases in a direction along axis 180, opposite the direction of taper 140 (e.g., in the negative direction of the x-axis of the frame of reference of FIG. 2A), to termination point 162, located in proximity to termination point 142 and having a width indicated w_tpr2_f. The length of taper 160 is indicated L_tpr2.

As shown in FIG. 2A, tapers 140 and 160 overlap in a projection of axis 150 onto axis 180. The length of taper 140 (e.g., L_tpr1) less the length of the overlap between tapers 140 and 160 is indicated in FIG. 2A as Dx multiplied by a scale factor (Dx*SF). Dx*SF may also be defined as the placement or displacement along axis 180 of termination point 162 with respect to the projection of base 128 of taper 140, onto axis 180. A length from base 128 of taper 140 to base 168 of taper 160 is indicated Ltotal. Layer 115 has a width indicated w_lyr. Off_rdgmin indicates the distance, or the transverse distance, between base 128 of taper 140 to the nearest edge of layer 115 (e.g., at the positive direction of the y-axis and along line B-B of FIG. 1).

FIGS. 2B and 2C illustrate side orthogonal views of optical coupler 100, showing the vertical profiles of ridges 120 and 130, respectively. FIG. 2B shows base 128 of taper 140 of ridge 120. The thickness of taper 140 and ridge 120 is indicated t_rdg1. Taper 140 is shown disposed on layer 115. The thickness of layer 115 is indicated t_lyr. FIG. 2C shows base 168 of taper 160 of ridge 130. The thickness of taper 160 and ridge 130 is indicated t_rdg2. Taper 160 is shown disposed on layer 115.

As an example, and with respect to FIGS. 2A-2C, the following dimensions were calculated for 640 nm target wavelength. The separation distance Dy between parallel axes 150 and 180 of tapers 140 and 160, respectively, may be approximately 200 nanometers (nm). The scale factor may vary from 5 to 10. The length of tapers 140 (L_tpr1) and 160 (L_tpr2) may be around one micrometer (μm) multiplied by the scale factor. The width of taper 140 at base 128 (e.g., at its widest point) (w_tpr1_i) may be approximately 330 nm, tapering down to 100 nm at termination point 142 (e.g., its narrowest point) (w_tpr1_f). The width of taper 160 may be at around 160 nm at base 168 (w_tpr2_i) and taper down to 100 nm at termination point 162 (w_tpr2_f). The thickness of ridge 120 (t_rdg1) may be 300 nm. The thickness of ridge 130 (t_rdg2) may be around 200 nm. The thickness of the layer may be approximately 100 nm. The width of layer 115 (w_lyr) may be one micrometer. The displacement Dx may be 600 nm multiplied by a scale factor which equals 10. Referring to FIG. 1, the thickness of BOX or ThOX layer 185 may be 3 micrometers.

According to some aspects, an optical coupler may be configured such that the first and second tapers do not overlap in a projection of the first axis onto the second axis. FIG. 3 illustrates an exemplary optical coupler 200 with this alternative configuration.

Reference is now made to FIG. 3, which shows a perspective view of optical coupler 200. According to some aspects, optical coupler 200 may include substantially the same components and features as the disclosed optical couplers, such as optical coupler 100 of FIG. 1, except where explicitly described otherwise herein. Optical coupler 200 includes a layer 215 of a first dielectric material disposed on a substrate which is a PIC 210. Optical coupler 200 further includes a ridge 220 and a ridge 230. Ridge 220 includes the first dielectric material and is disposed on layer 215 along an axis 250, where axis 250 is parallel to the x-axis of the frame of reference of FIG. 3. Ridge 220 terminates in a taper 240 having a varying width that decreases in a direction (e.g., in the positive direction of the x-axis of the frame of reference) along axis 250 to a termination point 242. Ridge 230 includes a second dielectric material and is disposed along an axis 280, which is parallel to axis 250. Ridge 230 terminates in a taper 260 having a varying width that decreases in a direction, opposite the direction at which the width of taper 240 decreases (e.g., in the negative direction of the x-axis of the frame of reference), along axis 280 to a termination point 262. Taper 240 and taper 260 in this exemplary configuration taper in a symmetric manner. According to some aspects, tapers 240 and 260 may be both asymmetric or one of tapers 240 and 260 may be symmetric and the other one asymmetric. According to some aspects, axis 280 may be displaced transversely from the axis 250 by a separation Dy. Ridge 220 and ridge 230 include a waveguide region 225 and 264, respectively. Waveguide regions 225 and 264 may be similar to waveguide regions 125 and 164 of optical coupler 100 of FIG. 1, respectively. Ridge 230 may further include a taper 265 and an interface 270, which may be similar to taper 165 and interface 170 of optical coupler 100 of FIG. 1, respectively. Ridge 230 may also include a qubit region 275 including one or more cavities such as cavity 195 and suspended in air, similarly to qubit region 175 of optical coupler 100 of FIG. 1. Similarly to optical coupler 100 of FIG. 1, optical coupler 200 is disposed on PIC 210, which includes a BOX or ThOX 285 and a substrate 290. According to some aspects, optical coupler 200 may include PIC 210.

According to some aspects, axis 250 and axis 280 are aligned so that Dy equals zero (Dy=0). According to some aspects, any deviation from Dy=0 may be considered as alignment error in the y-axis, to which an optical coupler having a non-overlapping configuration such as optical coupler 200 is more robust compared to an optical coupler having an overlapping configuration, such as optical coupler 100 of FIG. 1.

In this configuration, the first and second tapers, e.g., tapers 220 and 230, respectively, do not overlap when projected onto a common axis parallel to axes 250 and 280, e.g., axis 245. A plurality of points A′-I′ along axis 245 indicate the projection of the various components or regions of optical coupler 200, including ridges 220 (indicated by section A′C′ along axis 245) and 230 (indicated by section D′I′ along axis 245), onto axis 245. Taper 220 ends (indicated by point C′ along axis 245) before taper 230 begins (indicated by point D′) along the direction of optical propagation. This non-overlapping configuration may accommodate a separation between axis 250 and 280 which translates to a gap between taper 240 and taper 260 along the y-axis while light is still guided via layer 215 thus achieving high coupling. This non-overlapping configuration may provide different coupling characteristics compared to the overlapping taper configuration described with respect to FIGS. 1 and 2A. For example, the non-overlapping configuration is more resilient to variance in Dy at the expense of a more limited variance in Dx. According to some aspects, the non-overlapping configuration may allow higher coupling for short taper geometry (e.g., when SF=5, compared to the overlapping configuration shown, for example, in FIG. 1).

The optical coupler with non-overlapping tapers may be employed in similar applications as the overlapping taper embodiment, including integration of dissimilar materials or interfacing between photonic integrated circuits and quantum components. The choice between overlapping and non-overlapping configurations may depend on specific design requirements, fabrication constraints, performance targets for a given application or micro-transfer printing constraints.

Although the second ridge of optical couplers 100 of FIG. 1 and optical coupler 200 of FIG. 3 include an end region (e.g., qubit region 175 of ridge 130 of optical coupler 100 or qubit region 275 of ridge 230 of optical coupler 200) which is suspended in air, other configurations may include such an end portion embedded in another medium of refractive index lower than the second refractive index of the second ridge or sitting directly atop the layer (e.g., layer 115 of FIG. 1 or layer 215 of FIG. 3).

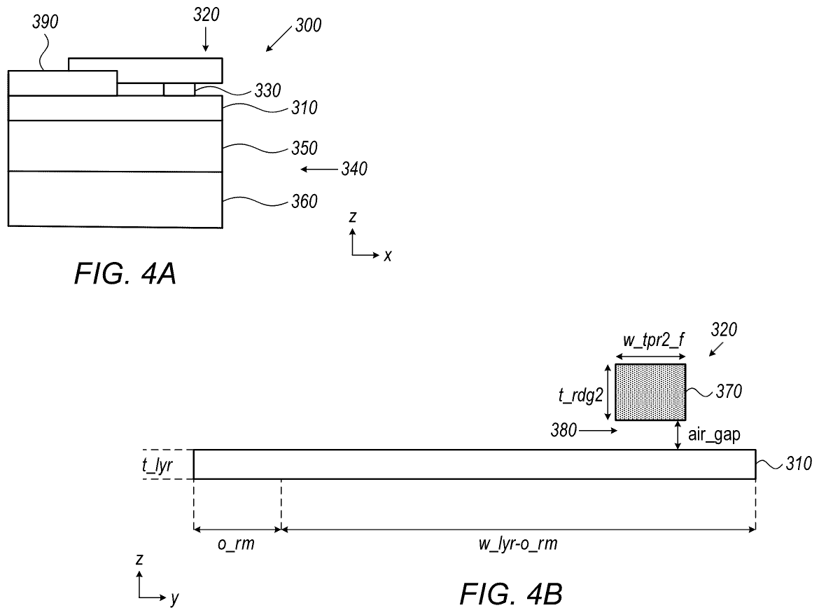

According to some aspects, an optical coupler may include an alternative configuration with an air gap between the second ridge and the layer. Reference is now made to FIGS. 4A and 4B, which illustrate views of an exemplary optical coupler 300 with this alternative configuration. FIG. 4A shows a side view along a plane x-z of an optical coupler 300, disposed on a PIC 340. FIG. 4B shows cross-section views of the second ridge (a ridge 320) and the layer (a layer 310) of optical coupler 300 of FIG. 4A, along a plane y-z. The cross-sections are at a base 370 of the taper of ridge 320, as positioned one with respect to the other. According to some aspects, optical coupler 300 may include substantially the same components and features as the disclosed optical couplers, such as optical coupler 100 of FIGS. 1-2C or optical coupler 200 of FIG. 3, except where explicitly described otherwise herein.

Referring to FIG. 4A, optical coupler 300 is disposed on or may include a PIC 340. PIC 340 includes a substrate 360 (e.g., silicon (Si) substrate) with a BOX layer or ThOX 350 formed above the substrate. Layer 310 (e.g., silicon nitride (SiN) layer), disposed on BOX or ThOX layer 350, a first ridge, ridge 390, and a second ridge, ridge 320 (e.g., a diamond ridge), may be similar to optical couplers 100 and 200.

Optical coupler 300 further includes a metal film 330 deposited over layer 310. Metal film 330 may serve multiple purposes, including providing electrical connectivity. Ridge 320 is mounted on metal film 330. Metal film 330 is deposited over layer 310 and ridge 320 is mounted on metal film 330 such that an air gap 380 (indicated in FIG. 4B) is present between ridge 320 and layer 310. According to some aspects, the metal film may serve as a contact to control the coupled qubit or to apply strain on a qubit via electrostatic attraction to another contact.

FIG. 4B clearly shows air gap 380 and dimensional relationships of layer 310, ridge 320 and air gap 380. The width of ridge 320 at base 370 of its taper (e.g., having the largest width of its taper) is indicated w_tpr2_f. The thickness of ridge 320 is indicated t_rdg2. The width of layer 310 is indicated w_lyr and the thickness of layer 310 is indicated t_lyr. The thickness of air gap 380 is indicated air_gap. According to some aspects, the thickness of layer 310 is 100 nm. According to some aspects, the thickness of metal layer 330 is equal to or between 10 to 20 nm. According to some aspects, the thickness of the air gap may be between 0 and 30 nm or may be equal to 30 nm.

According to some aspects, the formation or addition of an air gap, as disclosed, may provide various advantages. For example, in case of locally poor adhesion of a ridge 320 made of diamond to layer 310, made of SiN (which may happen after ridge 320 is transferred onto PIC 340), the air gap may provide significant robustness. In some cases, the air gap may be used for contacting a diamond qubit via a metal interface sitting between ridge 320, which is made of diamond, and layer 310, which is made of SiN. This configuration may allow for electrical connections to be made to the qubit while maintaining optical coupling through the structure.

According to simulations, the adiabatic coupling geometry of this configuration allows for the presence of an air gap between the diamond and SiN layer (e.g., slab) while still maintaining high coupling efficiency. For example, for a target wavelength of about 640 nm and a 5 μm long taper with a separation Dy between the two ridges of 100 nm, an air gap of 20 nm may result in only a 3% decrease in light transmission (from 96.3% to 93.4%).

The above dimensions are provided as examples and may be adjusted based on specific design requirements, target wavelengths, or material properties. The ability to accommodate dimensional variations while maintaining high coupling efficiency demonstrates the robustness of this optical coupler design.

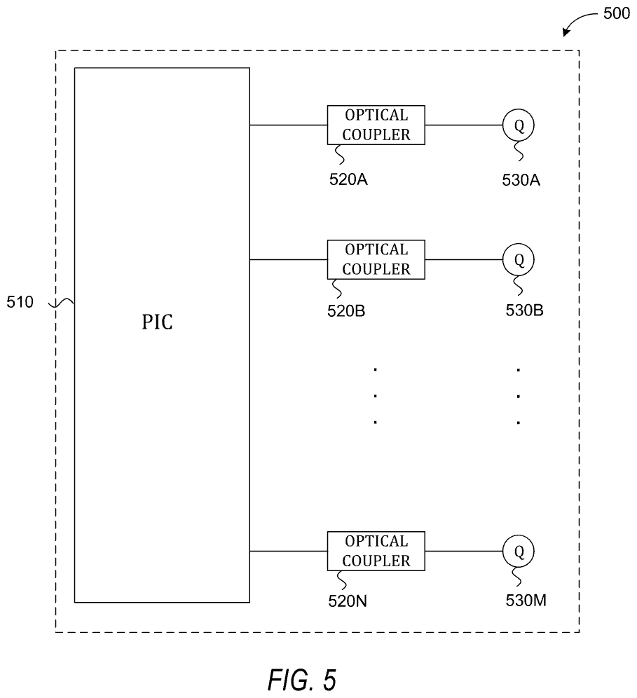

According to some aspects, an optical coupler as disclosed may be integrated into a quantum processor. Reference is now made to FIG. 5, which illustrates a schematic block diagram of an exemplary quantum processor 500 incorporating multiple optical couplers 520A-520N. According to some aspects, each optical coupler of optical couplers 520A-520N may be selected to be one of optical coupler 100 of FIGS. 1-2C, optical coupler 200 of FIG. 3 or optical coupler 300 of FIG. 4. According to some aspects, all optical couplers 520A-520N are of the same configuration, e.g., are according to one of optical coupler 100, optical coupler 200 or optical coupler 300.

Quantum processor 500 may further include multiple qubits 530A-530M and at least one Photonic Integrated Circuit (PIC) platform 510. Each optical coupler of optical couplers 520A-520N may be coupled with one or more qubits of qubits 530A-530M, while M≥N. Optical couplers 520A-520N may be disposed or formed on at least one PIC, such as PIC 510.

According to some aspects, one or more or all of qubits 530A-530N are diamond qubits. According to some aspects, the second ridge of one or more or all of optical couplers 520A-520N, which interfaces with the qubit component, may be formed from diamond material. According to some aspects, a diamond second ridge of an optical coupler of optical couplers 520A-520N may include respectively coupled one or more diamond qubits. This configuration allows for direct integration of the qubit into the coupling structure.

According to some aspects, one or more optical couplers of optical couplers 520A-520N may include a cavity, as shown, for example, in FIGS. 1 and 3 (cavity 195 and 295, respectively). This cavity may host a color center, which forms the basis of a qubit. According to some aspects, the color center may be a nitrogen-vacancy (NV) center in the diamond material of the second ridge (e.g., ridge 130 of FIG. 1 or ridge 230 of FIG. 3).

According to some aspects, each qubit of at least a portion of the multiple qubits may be coupled with two optical couplers according to the disclosure, e.g., an optical coupler may be added from East and another optical coupler may be added from West to the qubit or its respective resonator (e.g., mirrored optical couplers). In such a configuration, the East and West optical couplers may be designed for the same target wavelength or for different target wavelengths (e.g., red and green). For example, in some implementations it may be desirable to have green light coupling to the qubit for initialization purposes, while having the respective resonator coupled to a red optical coupler to resonantly excite the qubit or to collect qubit emissions. Some of the excitation signals may be used at Transverse Electric (TE) or Transverse Magnetic (TM) polarizations.

FIG. 5 is a schematic block diagram provided for illustrative purposes only, depicting logical functions or components of a quantum processor in accordance with the present disclosure. FIG. 5 is not intended to represent the actual physical structure, layout, or geometry of the quantum processor.

The disclosed optical couplers may allow for scalable integration of multiple qubit-PIC coupling units. The use of the disclosed optical couplers may provide efficient and robust coupling between the qubits and the PICS, even in the presence of fabrication variations or alignment uncertainties. This may further contribute to the overall performance and reliability of the quantum processor system.

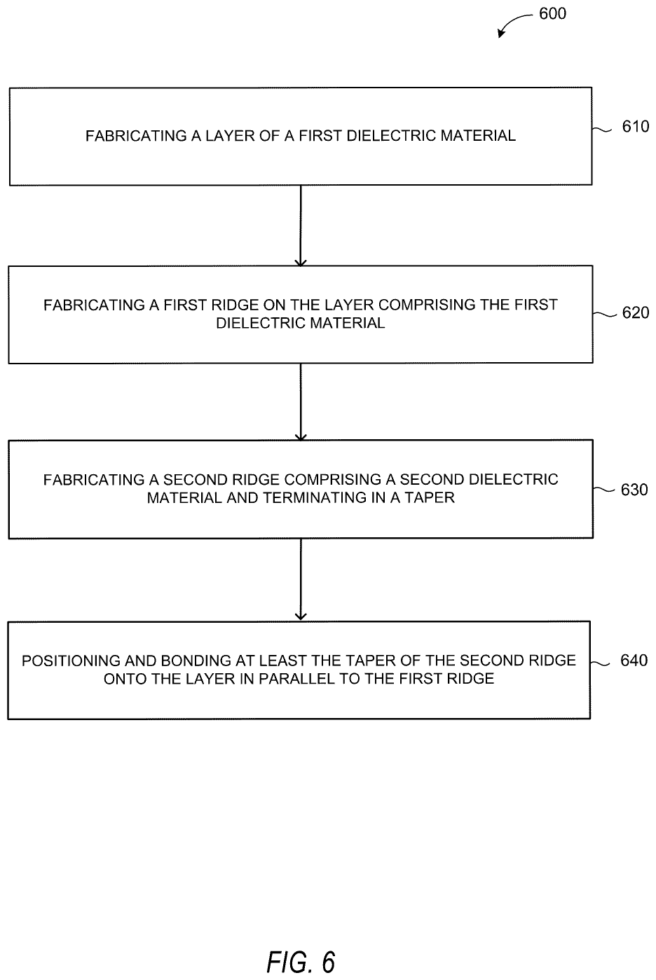

Reference is now made to FIG. 6, which shows a flowchart of a method 600 for fabricating an optical coupler, such as optical coupler 100 of FIG. 1, optical coupler 200 of FIG. 3 or optical coupler 300 of FIG. 4, for operation at a target wavelength. The method includes several steps for creating and assembling the components of the optical coupler.

At a step 610, a layer (e.g., layer 115 of FIG. 1 or layer 215 of FIG. 3) of a first dielectric material having a first refractive index at the target wavelength is fabricated. According to some aspects, the first dielectric material may be silicon nitride (SiN). According to some aspects, fabricating the layer may include forming the layer on a substrate, such as a PIC platform (e.g., PIC 110 of FIG. 1 or PIC 210 of FIG. 3).

At a step 620, a first ridge (e.g., ridge 120 of FIG. 1 or ridge 220 of FIG. 2) along a first axis (e.g., axis 150 of FIGS. 1 and 2A or axis 250 of FIG. 3) is fabricated on the layer. The first ridge includes the first dielectric material and terminates at a first termination point. According to some aspects, the first ridge may terminate in a first taper (e.g., taper 140 of FIG. 1 or taper 240 of FIG. 2). The first taper may have a first varying width that decreases in a first direction along the first axis to the first termination point (e.g., termination point 142 of FIG. 1 or termination point 242 of FIG. 2). According to some aspects, the length of the first taper may be between twice and twenty times the target wavelength.

According to some aspects, in case the layer is fabricated on a substrate, post fabrication of the first taper, which is likely done in the Front End of Line (FEOL), the substrate, e.g., a PIC, may pass through various Back End of Line (BEOL) processes. Such BEOL processes may include a step of forming elements such as phase shifters, thermal tuners, or various metal layers, via, Chemical Mechanical Planarizations (CMPs), passivation, deposition, lithography etc. The BEOL passivation above the transition region may be etched down to expose the first taper for micro-transfer printing operation. This may be performed locally only at the optical coupler and qubit integration region. Elsewhere the BEOL stays as fabricated. In addition, the first taper may follow other FEOL processes preceding it. Furthermore, additional FEOL processes may be performed after formation of the first taper and before the processes move to BEOL. Finally, the first taper may be produced at BEOL as well.

At a step 630, a second ridge including a second dielectric material is fabricated (e.g., ridge 130 of FIG. 1, ridge 230 of FIG. 3, or ridge 320 of FIG. 4). The second dielectric material may have a second refractive index greater than the first refractive index at the target wavelength. According to some aspects, the second dielectric material may be diamond. According to some aspects, the second dielectric material may include Lithium Niobate or Barium Titanate. The second ridge may terminate in a taper (e.g., taper 160 of FIG. 1 or taper 260 of FIG. 3) having a second width that decreases to a second termination point (e.g., termination point 162 of FIG. 1 or termination point 262 of FIG. 3).

At a step 640, at least the taper of the second ridge is positioned and bonded onto the layer along a second axis (e.g., axis 180 of FIGS. 1 and 2A or axis 280 of FIG. 3). The second axis may be parallel to the first axis. The positioning and bonding may be performed such that the varying width of the taper decreases in a direction along the second axis to the second termination point in proximity to the first termination point. According to some aspects, where the first ridge includes a first taper, the second ridge includes a second taper. The at least second taper of the second ridge may then be positioned and bonded onto the layer so that the second varying width of the second taper decreases in a second direction, opposite the first direction, along the second axis to the second termination point in proximity to the first termination point. According to some aspects, the second axis may be displaced transversely from the first axis by a separation (indicated Dy in FIGS. 1, 2A and 3). According to some aspects, the positioning and bonding of the at least second taper of the second ridge onto the layer may be performed so that the error in displacement (indicated Dx in FIGS. 1, 2A and 3) along the second axis of the second termination point of the second taper from the projection of a base (e.g., base 128 of FIGS. 1-2B or base 228 of FIG. 3) of the first taper (e.g., at which the first taper begins or has the largest width) onto the second axis, may be within a range of ±150% of the target wavelength.

According to some aspects, the positioning and bonding of the second ridge may be performed by micro-transfer printing. This technique may allow for precise placement of the second ridge onto the layer.

According to some aspects, the positioning and bonding of the second ridge may be performed so that the second axis is displaced transversely from the first axis by a separation and the first and second tapers overlap in a projection of the first axis onto the second axis, as shown, for example, in FIGS. 1 and 2A.

Alternatively, the positioning and bonding may be performed such that the first and second tapers do not overlap in a projection of the first axis onto the second axis, as shown, for example in FIG. 3. According to some aspects, positioning of the second ridge and bonding of at least the second taper onto the layer may be performed so that the first axis and the second axis are aligned. According to some aspects, positioning of the second ridge and bonding of at least the second taper onto the layer may be performed so that the second axis is displaced transversely from the first axis by a separation.

According to some aspects, the first and second tapers may taper asymmetrically. According to some aspects, for an overlapping configuration, the positioning of the second ridge and bonding of at least the second taper onto the layer may then be performed so that the second axis is displaced transversely from the first axis by a separation which is between 23% and 70% of the target wavelength.

According to some aspects, at least one taper, e.g., of the first and second tapers may taper symmetrically. According to some aspects, for the non-overlapping configuration, where the first and second tapers taper symmetrically, the positioning of the second ridge and bonding of at least the second taper onto the layer may then be performed so that the second axis is displaced transversely from the first axis by a separation which is ±30% of the target wavelength.

According to some aspects, the method may further include a step of depositing a metal film over the layer. In such cases, positioning of the second ridge and bonding of at least the second taper onto the layer may include mounting the second ridge onto the metal film so that there is an air gap between the second ridge and the layer, as shown, for example, in FIGS. 4A and 4B.

According to some aspects, the positioning and bonding of the second ridge may be performed so that an end portion of the second ridge, opposite the second taper, is suspended in or disposed on a third transparent dielectric material having a third refractive index lower than the second refractive index. According to some aspects, the third refractive index is also lower than the first refractive index. For example, the end portion of the second ridge may be suspended in air, as shown, for example, in FIGS. 1 and 3, where the end portion is a qubit region 175 or qubit region 275, respectively.

According to some aspects, the method may further include a step of applying glass passivation to the optical coupler subsequent to the positioning and bonding of the at least second taper of the second ridge. Implementing glass passivation, e.g., post-pick and place, may relax the pick and place precision needed. According to some aspects, this relaxed precision may enable simultaneous multi-qubit pick and place transfer printing, thus leading to a much cheaper integration process.

The fabrication method described may enable the creation of optical couplers with high coupling efficiency and relaxed alignment tolerances, suitable for various applications in integrated photonics and for quantum computing systems, in particular.

The disclosed optical coupler geometry has many advantages, including a higher tolerance to misalignment along the y-axis (e.g., in the separation Dy), having high coupling efficiency with a smaller taper length, keeping high coupling efficiency at relatively high uncertainty in the placement along the y-axis (Dy) and along the x-axis (Dx displacement), allowing the addition of structures in the ridge layer to serve as locks and allowing placement of alignment marks in the same ridge layer.

High coupling efficiency can be achieved with a relatively small taper length (in x-axis), unlike and with respect to evanescent couplers.

The coupling efficiency remains high even at relatively high uncertainty in the placement along the y-axis (e.g., ΔDy of ±100 nm) and very high uncertainty in the placement along the x-axis (e.g., ΔDx of ±1000 nm).

The disclosed optical coupler may be used to couple not only TE-polarization, but also TM polarization. In the present context, TE polarization may refer to the polarization of the lowest order mode of the single mode waveguide before and after the taper for which the electric field is predominantly oriented in the y axis. TM polarization may refer to the polarization of the lowest order mode of the single mode waveguide before and after the taper for which the electric field is predominantly oriented in the z axis. For example according to simulations, adiabatic transition at SF=5 and minimum SiN taper width of 150 nm may allow for coupling of 83.7% of TM polarized red light without any further optimization.

According to some aspects, additional structures may be fabricated in the ridge layer to act as “stop” barriers elsewhere in the chiplet (not shown in the FIGS.). Such locks are used in micro-transfer printing to constrain movement of the source structure in one or both axes (in this case the second ridge, e.g., diamond ridge, in the y-axis) while bonding.

According to some aspects, alignment marks may be placed in the same ridge layer, where the first ridge (e.g., SiN ridge) is etched via the same lithography mask and etching. This may further improve the alignment procedure of micro-transfer-printing.

Dx and Dy may have the dominant uncertainty and may be determined by the precision of the micro-transfer printing technology. Thus, the coupling efficiency was checked in simulations as a function of Dx, Dy and target wavelength. It was found that the disclosed coupling allows placement of a diamond qubit within precision limits, which are achievable with state-of-the-art single die pick and place capabilities. This is while maintaining coupling efficiency of 94-99%.

For example, for the non-overlapping tapers, a Dy change of ±100 nm (e.g., +15% for a wavelength of 640 nm) and a Dx change of ±250 nm (±39% for the 640 nm wavelength) result in less than a 5% decrease in the maximum coupling of 98.8% for SF=5. Similar coupling robustness may be achieved for Dx as high as ±2 um (e.g., ±312.5% for the 640 nm wavelength) for a 10 um long adiabatic taper and with ±100 nm (e.g., ±15% for a wavelength of 640 nm) of variation in Dy, for the overlapping tapers.

Further simulations have been conducted. It was further found that the disclosed coupling scheme is robust to process variation in SiN and diamond thickness, minimum width achievable by lithography, partial etch depth, and inter-mask misalignment in state-of-the-art photonic fabs.

For example, results of the inventors' analysis include: SiN taper tip width variation of ±20 nm, which results in ±1% variation of the Coupling Efficiency (CE); SiN layer width variation of ±50 nm results in −0.4% decrease in CE; SiN layer thickness variation of ±20 nm results in −0.8% decrease in CE; diamond taper tip width variation of ±20 nm results in <4% decrease in CE.

The coupler size may be scaled down, e.g., by a factor of ½ relative to the 10 um long taper (where scale_factor=10), as indicated above, without significant reduction of the coupling efficiency.

Limited taper tip width of some silicon photonics fabrication facilities (Si-Photonic fabs) may be compensated by varying coupler geometry. For example, a further increase in the minimum SiN taper width from 100 nm to 150 nm still allows for CE of 97%.

The disclosed optical coupling may be used with all wavelengths for which the materials the optical coupler is made of are dielectric and transparent (e.g., visible light or Near-Infrared (NIR)). The disclosed optical coupling, as designed for a target wavelength, may retain 90% of its performance with a deviation of 6% of the target wavelength in either direction.

The disclosed optical coupling may be used in additional fields such as telecommunication, data communication (datacom), Light Detection and Ranging (LIDAR) and sensing, where integration of optical materials that are not native to Silicon (Si) (e.g., cannot be grown in Si) or are incompatible with Complementary Metal-Oxide-Semiconductor (CMOS) processing may be highly beneficial. Such materials may include III-V, II-VI (e.g., Indium Phosphide (InP), Gallium Arsenide (GaAs), Mercury Cadmium Telluride (HgCdTe), Lithium Niobate (LNO), Barium Titanate (BTO), and the like), implemented as lasers, detectors, modulators, amplifiers, isolators etc. on a different material system and printed onto Si-made PIC.

A number of implementations have been described. Nevertheless, it will be understood that various modifications may be made without departing from the spirit and scope of the disclosure. Accordingly, other implementations are within the scope of the following claims.

1. An optical coupler for operation at a target wavelength, the device comprising:
a layer of a first dielectric material, having a first refractive index at the target wavelength;
a first ridge comprising the first dielectric material, which is disposed on the layer along a first axis and is configured to guide an optical wave at the target wavelength, and which terminates at a first termination point; and
a second ridge comprising a second dielectric material, which has a second refractive index greater than the first refractive index at the target wavelength and is disposed along a second axis, which is parallel to the first axis, and terminates in a taper, disposed on the layer, having a varying width that decreases in a direction, along the second axis to a second termination point in proximity to the first termination point, whereby the guided optical wave is adiabatically coupled between the first and second ridges.

2. The optical coupler according to claim 1, wherein the first dielectric material is silicon nitride (SiN).

3. The optical coupler according to claim 1, wherein the second dielectric material is diamond.

4. The optical coupler according to claim 1, wherein the first ridge terminates in a first taper having a first varying width that decreases in a first direction along the first axis to the first termination point, and wherein the second ridge terminates in a second taper that decreases in a second direction, opposite the first direction, along the second axis to the second termination point.

5. The optical coupler according to claim 4, wherein the second axis is displaced transversely from the first axis by a separation and wherein the first and second tapers overlap in a projection of the first axis onto the second axis.

6. The optical coupler according to claim 5, wherein the second axis is displaced transversely from the first axis by a separation which is between 23% and 70% the target wavelength.

7. The optical coupler according to claim 4, wherein the first and second tapers do not overlap in a projection of the first axis onto the second axis.

8. The optical coupler according to claim 7, wherein the first axis and the second axis are aligned.

9. The optical coupler according to claim 7, wherein the second axis is displaced transversely from the first axis by a separation.

10. The optical coupler according to claim 9, wherein the second axis is displaced transversely from the first axis by a separation which is ±30% of the target wavelength.

11. The optical coupler according to claim 5, wherein the error in displacement along the first and second axes of the second termination point of the second taper with respect to the point along the first ridge at which the first taper begins is within a range of ±150% of the target wavelength.

12. The optical coupler according to any one of claim 1, wherein an end portion of the second ridge, opposite the second taper, is suspended in or disposed on a third transparent dielectric material having a third refractive index lower than the second refractive index.

13. The optical coupler according to claim 1, wherein the second ridge is mounted on a metal film disposed over the layer of the first dielectric material so that there is an air gap between the second ridge and the layer.

14. The optical coupler according to claim 1, further comprising a substrate, wherein the layer is disposed on the substrate.

15. A quantum processor comprising:
multiple qubits;
at least one Photonic Integrated Circuit (PIC) platform; and
multiple optical couplers, wherein each optical coupler of the multiple optical couplers is according to claim 1 and is disposed on a respective PIC platform of the at least one PIC platform,
wherein each optical coupler of the multiple optical couplers is configured to couple between one or more qubits of the multiple qubits and the respective PIC platform.

16. A method for fabricating an optical coupler for operation at a target wavelength, the method comprising:
fabricating a layer of a first dielectric material, having a first refractive index at the target wavelength;
fabricating a first ridge along a first axis on the layer, the first ridge comprising the first dielectric material, and terminating at a first termination point;
fabricating a second ridge comprising a second dielectric material, having a second refractive index greater than the first refractive index at the target wavelength, and terminating in a taper having a varying width that decreases to a second termination point; and
positioning the second ridge and bonding at least the taper onto the layer along a second axis, parallel to the first axis, such that the varying width of the taper decreases in a direction along the second axis to the second termination point in proximity to the first termination point.

17. The method according to claim 16, wherein the positioning and bonding of the second ridge is performed by micro-transfer printing.

18. The method according to claim 16, further comprising applying glass passivation to the optical coupler subsequent to the positioning and bonding of the second ridge.

19. The method according to claim 16, wherein fabricating the layer comprises forming the layer on a substrate.

20. The method according to claim 16, wherein the first dielectric material is silicon nitride (SiN) and the second dielectric material is diamond.

21. The method according to claim 16, wherein:
the first ridge terminates in a first taper having a first varying width that decreases in a first direction along the first axis to the first termination point,
the second ridge terminates in a second taper that decreases in a second direction, opposite the first direction, along the second axis to the second termination point, and
positioning and bonding of the second ridge is performed so that the second varying width of the second taper decreases in a second direction, opposite the first direction, along the second axis to the second termination point.

22. The method according to claim 21, wherein positioning of the second ridge and bonding of at least the second taper onto the layer is performed so that the second axis is displaced transversely from the first axis by a separation and the first and second tapers overlap in a projection of the first axis onto the second axis.

23. The method according to claim 22, wherein positioning of the second ridge and bonding of at least the second taper onto the layer is performed so that the second axis is displaced transversely from the first axis by a separation which is between 23% and 70% the target wavelength.

24. The method according to claim 21, wherein positioning of the second ridge and bonding of at least the second taper onto the layer is performed so that the first and second tapers do not overlap in a projection of the first axis onto the second axis.

25. The method according to claim 24, wherein positioning of the second ridge and bonding of at least the second taper onto the layer is performed so that the first axis and the second axis are aligned.

26. The method according to claim 24, wherein positioning of the second ridge and bonding of at least the second taper onto the layer is performed so that the second axis is displaced transversely from the first axis by a separation.

27. The method according to claim 26, wherein positioning of the second ridge and bonding of at least the second taper onto the layer is performed so that the second axis is displaced transversely from the first axis by a separation which is ±30% of the target wavelength.

28. The method according to claim 21, wherein positioning of the second ridge and bonding of at least the second taper onto the layer is performed so that an end portion of the second ridge, opposite the second taper, is suspended in or disposed on a third transparent dielectric material having a third refractive index lower than the second refractive index.

29. The method according to claim 16, further comprising depositing a metal film over the layer, wherein positioning of the second ridge and bonding of at least the second taper onto the layer comprises mounting the second ridge onto the metal film so that there is an air gap between the second ridge and the layer.
